(19) United States
(12) Patent Application Publication
(10) Pub. No.: US 2006/0098337 A1
(43) Pub. Date: May 11, 2006

(54) Tungsten heat sink structures in a thin film magnetic head

(76) Inventors: Hung-Chin Guthrie, Saratoga, CA (US); Ming Jiang, San Jose, CA (US); Samuel Wei-san Yuan, Saratoga, CA (US)

Correspondence Address: INTELLECTUAL PROPERTY LAW OFFICES, 1901 SOUTH BASCOM AVENUE, SUITE 660, CAMPBELL, CA, 95008, US

(21) Appl. No.: 10/985,527

(22) Filed: Nov. 10, 2004

(51) Int. Cl. G11B 5/147; G11B 5/127

(52) U.S. Cl. 360/126; 360/128

(57) ABSTRACT

A magnetic head having one or more tungsten heat sinks is disposed within the magnetic head to draw heat away from the components of the head to limit unwanted thermal expansion and protrusion of the components of the magnetic head into the air bearing gap. In a first embodiment, a tungsten heat sink is fabricated upon the magnetic head substrate, immediately prior to the fabrication of the first magnetic shield. In another embodiment, a tungsten heat sink is fabricated immediately following the fabrication of the second magnetic shield. In a further embodiment the tungsten heat sink is fabricated following the fabrication of the second magnetic pole of the write head portion of the magnetic head. An enhanced embodiment may contain two or all three of the heat sinks described above. In fabricating the heat sinks, photolithographic fabrication techniques, as are well known to those skilled in the art, are utilized.

### BACKGROUND OF THE INVENTION

1. Field of the Invention

The present invention relates generally to magnetic heads having inductive write head structures, and more particularly to such magnetic heads having tungsten heat sink structures formed therein for the dissipation of heat generated within the head.

2. Description of the Prior Art

Hard disk drives include magnetic heads that are designed to write data in narrow data tracks upon the data disk of the disk drive, and to read data from the narrow data tracks. When reading and writing data from the disk, the magnetic head is disposed on a moving film of air, termed an air bearing, above the rotating disk. The ongoing effort to increase the areal data storage density of the hard disk drive results in the development and usage of ever smaller magnetic pole tips and magnetoresistive sensors for writing and reading increasingly smaller data bits onto the disk. Additionally, the air bearing gap, that is, the distance between the magnetic head and the surface of the rotating disk, is also reduced to facilitate the writing and reading of data to and from the disk.

As is well known, the data writing process involves the use of an induction coil to generate magnetic fields within the magnetic poles of the write head, and the electrical current within the induction coil generates a significant amount of heat. The heat creates thermal expansion of the structures within the magnetic head, thereby causing protrusion of the magnetic head structures into the air bearing gap. This unwanted protrusion reduces the effective air bearing gap distance in an inconsistent manner depending upon the temperature of the magnetic head. In turn, this creates undesirable inconsistency in the magnetic head writing and reading performance characteristics. It is therefore desirable to incorporate heat sink structures within the magnetic head that function to draw the unwanted heat away from the magnetic head structures in order to reduce unwanted protrusion and promote operational reliability of the magnetic head. The magnetic head of the present invention includes tungsten heat sink structures, as is described hereinbelow.

### SUMMARY OF THE INVENTION

In the magnetic head of the present invention one or more tungsten heat sink structures is disposed within the magnetic head to draw heat away from the components of the head. In a first embodiment, a tungsten heat sink is fabricated upon the magnetic head substrate, immediately prior to the fabrication of the first magnetic shield. This heat sink structure functions to transfer heat from the magnetic head to the substrate base to thereby limit unwanted thermal expansion and protrusion of the components of the magnetic head into the air bearing gap. In another embodiment of the present invention, a tungsten heat sink structure is fabricated immediately following the fabrication of the second magnetic shield. Again the heat sink functions to inhibit the thermal expansion of the magnetic head components which lead to the unwanted protrusion of the magnetic head components into the air bearing gap. In another embodiment of the present invention, the tungsten heat sink structure is fabricated following the fabrication of the second magnetic pole of the write head portion of the magnetic head. As with the prior embodiments, the heat sink functions to inhibit the thermal expansion of magnetic head components and thereby limits unwanted protrusion of the magnetic head components into the air bearing gap. Additionally, an enhanced embodiment of a magnetic head of the present invention may contain two or all three of the heat sink structures described above. In fabricating the heat sink structures, photolithographic fabrication techniques, as are well known to those skilled in the art, are utilized to fabricate the heat sink structures in the desired locations.

It is an advantage of the magnetic head of the present invention that a tungsten heat sink is provided to reduce thermal expansion of components of the magnetic head.

It is another advantage of the magnetic head of the present invention that a tungsten heat sink is provided to reduce thermal protrusion of components of the magnetic head into the air bearing gap.

It is a further advantage of the magnetic head of the present invention that it includes at least one heat sink that is composed of a material which has a relatively low coefficient of thermal expansion.

It is yet another advantage of the magnetic head of the present invention that it includes a heat sink that is composed of a material which has a relatively high Young's Modulus.

It is an advantage of the hard disk drive of the present invention that it includes a magnetic head of the present invention in which a tungsten heat sink is provided to reduce thermal expansion of components of the magnetic head.

It is another advantage of the hard disk drive of the present invention that it includes a magnetic head of the present invention in which a tungsten heat sink is provided to reduce thermal protrusion of components of the magnetic head into the air bearing gap.

It is a further advantage of the hard disk drive of the present invention that it includes a magnetic head of the present invention that includes at least one heat sink that is composed of a material which has a relatively low coefficient of thermal expansion.

It is yet another advantage of the hard disk drive of the present invention that it includes a magnetic head of the present invention that includes a heat sink that is composed of a material which has a relatively high Young's Modulus.

These and other features and advantages of the present invention will no doubt become apparent to those skilled in the art upon reading the following detailed description which makes reference to the several figures of the drawing.

### IN THE DRAWINGS

The following drawings are not made to scale as an actual device, and are provided for illustration of the invention described herein.

FIG. 1 is a schematic top plan view of a hard disk drive including the magnetic head of the present invention;

FIG. 2 is a side cross-sectional view depicting various components of a prior art magnetic head;

FIG. 3 is a side cross-sectional view depicting various components of a magnetic head of the present invention;

FIG. 4 is a side cross-sectional view depicting various components of another embodiment of the magnetic head of the present invention;

FIG. 5 is a side cross-sectional view depicting various components of a further another embodiment of the magnetic head of the present invention; and

FIG. 6 is a side cross-sectional view depicting various components of yet another embodiment of the magnetic head of the present invention.

### DETAILED DESCRIPTION OF THE PREFERRED EMBODIMENTS

A simplified top plan view of a typical hard disk drive 10 which includes a magnetic head of the present invention is presented in FIG. 1. As depicted therein, at least one hard disk 14 is rotatably mounted upon a motorized spindle 18. A slider 22, having a magnetic head 26 disposed thereon, is mounted upon an actuator arm 30 to fly above the surface of each rotating hard disk 14, as is well known to those skilled in the art. The present invention includes improved features and manufacturing methods for such magnetic heads, and to better describe the present invention a prior art magnetic head is next described.

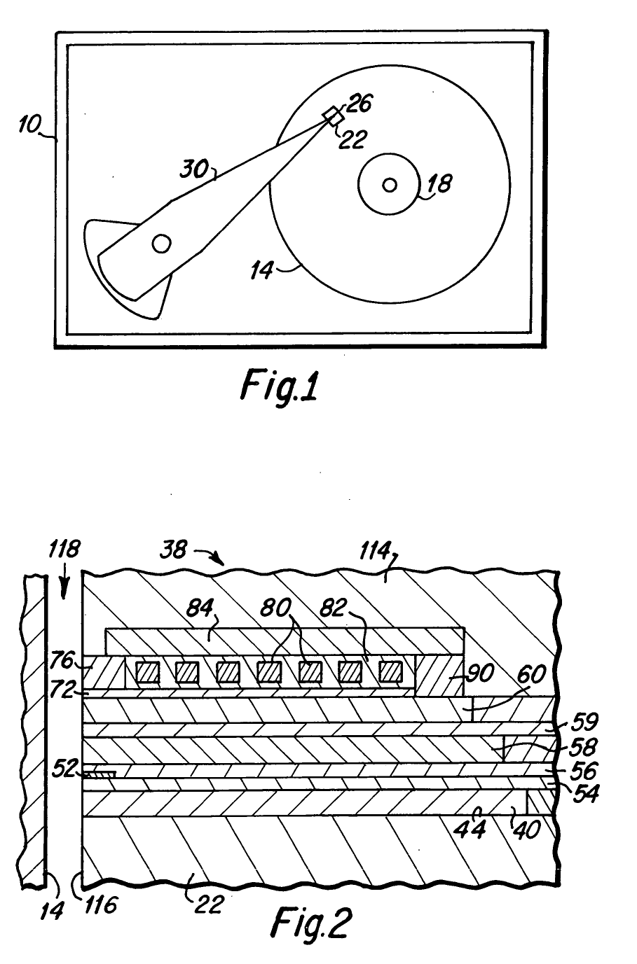

As will be understood by those skilled in the art, FIG. 2 is a cross-sectional view that depict portions of a prior art magnetic head 38. As is best seen in FIG. 2, the magnetic head 38 includes a first magnetic shield layer (S1) 40 that is formed upon a surface 44 of the slider substrate 22. A read head sensor element 52 is disposed within electrical insulation layers 54 and 56 and a second magnetic shield layer (S2) 58 is formed upon the insulation layer 56. An electrical insulation layer 59 is then deposited upon the S2 shield 58, and a first magnetic pole (P1) 60 is fabricated upon the insulation layer 59.

Following the fabrication of the P1 pole 60, a write gap layer 72 is deposited upon the P1 pole 60, followed by the fabrication of a P2 magnetic pole tip 76. An induction coil structure including coil turns 80 is then fabricated within insulation 82 above the write gap layer 72. Thereafter, a yoke portion 84 of the second magnetic pole is fabricated in magnetic connection with the P2 pole tip 76, and through back gap element 90 to the P1 pole 60. A further insulation layer 114 is deposited to encapsulate the magnetic head. The magnetic head 38 is subsequently fabricated such that an air bearing surface (ABS) 116 is created.

It is to be understood that there are many detailed features and fabrication steps of the magnetic head 38 that are well known to those skilled in the art, and which are not deemed necessary to describe herein in order to provide a full understanding of the present invention.

When the magnetic head 38 is installed in a hard disk drive 10 the air bearing surface 116 flies above the surface of the rotating disk 14, such that a gap 118, termed an air bearing gap, is created. When the magnetic head is utilized to write data, the induction coil 80 creates heat that causes the magnetic head components, particularly the magnetic poles 60 and 84 and the magnetic shields 40 and 58, to expand and to protrude into the air bearing gap 118. The protrusion is unwanted as it creates uncertainty in the performance characteristics of the magnetic head.

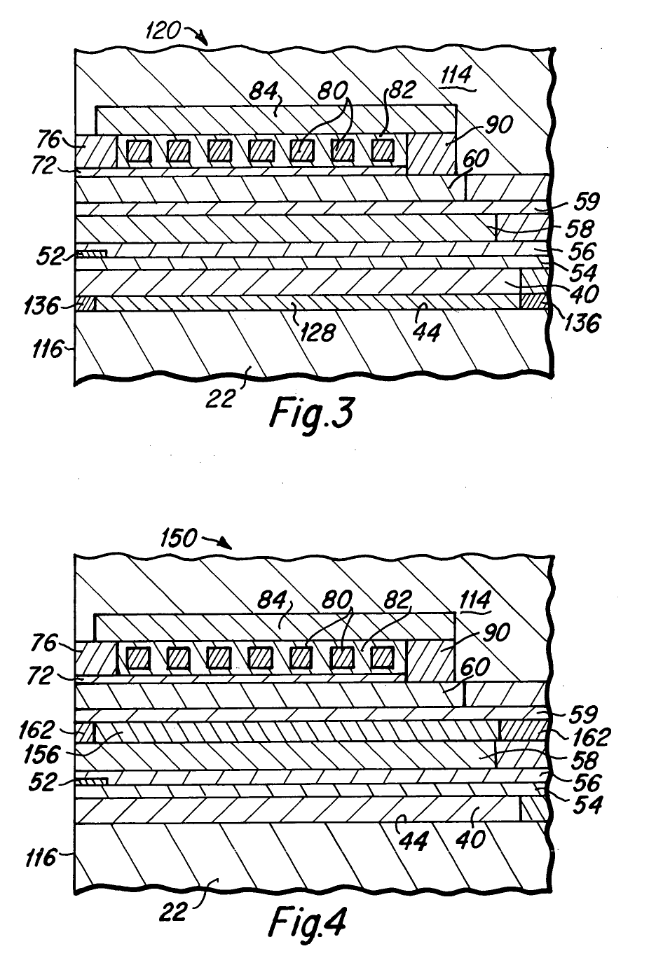

As will be understood from the following detailed description, the magnetic head of the present invention includes one or more tungsten heat sink structures that are fabricated within the magnetic head to draw away excess heat that is generated within the head. A first embodiment of a magnetic head 120 is depicted in FIG. 3 which is a side cross-sectional view of the magnetic head. The magnetic head 120 of the present invention, as depicted in FIG. 3 includes many structures and components of the prior art magnetic head depicted in FIG. 2, and similar structures are similarly numbered for ease of comprehension. Therefore, as depicted in FIG. 3, the magnetic head 120 includes a slider substrate 22 having an upper surface 44. A tungsten heat sink 128 is next fabricated upon the surface 44, and the tungsten heat sink 128 is surrounded by a fill layer 136 of an insulative material such as alumina.

Thereafter, further magnetic head components which may be components and structures that are substantially identical to the magnetic head 38 depicted in FIG. 2, are fabricated upon the tungsten heat sink structure. Specifically, the first magnetic shield 40 is next fabricated upon the tungsten heat sink 128 and alumina fill 136. A read head sensor element 52 is disposed within electrical insulation layers 54 and 56 and a second magnetic shield layer (S2) 58 is formed upon the insulation layer 56. An electrical insulation layer 59 is then deposited upon the S2 shield 58, and a first magnetic pole (P1) 60 is fabricated upon the insulation layer 59.

A write gap layer 72 is then deposited upon the P1 pole 60, followed by the fabrication of a P2 magnetic pole tip 76. An induction coil structure including coil turns 80 is then fabricated within insulation 82 above the write gap layer 72. Thereafter, a yoke portion 84 of the second magnetic pole is fabricated in magnetic connection with the P2 pole tip 76, and through back gap element 90 to the P1 pole 60. A further insulation layer 114 is deposited to encapsulate the magnetic head. The magnetic head 120 is subsequently fabricated such that an air bearing surface (ABS) 116 is created.

It is therefore to be understood that the tungsten heat sink 128 serves to absorb heat from the first magnetic shield 40, and therefore from other components of the magnetic head 120, and to transfer the heat to the substrate base 22 for further heat dissipation. As a result, heat is removed from the magnetic head 120, whereby thermal expansion of the components of the magnetic head is reduced, and undesirable protrusion of the magnetic head components into the air bearing gap is reduced.

As will be understood by those skilled in the art, the tungsten heat sink 128 can be fabricated in several ways. For instance, a tungsten layer can be deposited across the substrate surface, followed by a masking of the desired tungsten heat sink and an etching or chemical removal of the undesired portions of the deposited tungsten layer. Thereafter, an alumina fill can be deposited across the surface, followed by a chemical mechanical polishing (CMP) step to create a flat upper surface for the tungsten heat sink and surrounding alumina fill material. Alternatively, a photoresist in the shape of the tungsten heat sink can be fabricated upon the substrate surface, followed by the deposition of an alumina layer and the subsequent removal of the photoresist to create a heat sink trench within the fill layer. Tungsten can thereafter be deposited across the surface to fill the heat sink trench space formerly occupied by a photoresist, and a CMP process can be undertaken to achieve a flat upper surface of the alumina and tungsten heat sink surfaces. Other fabrication techniques are contemplated and included within the scope of the present invention.

As depicted in FIG. 3, and due to the heat sink fabrication process, the heat sink 128 is formed as a flat layer of material that will generally have a thickness from 0.2μ to approximately 4μ, and preferably approximately 2μ. From a top view (not shown) the heat sink 128 can generally be formed in the shape of the magnetic shield 40, so as to optimize heat transfer from the shield 40. Additionally, the upper portions of the heat sink 128, that is, those portions away from the ABS, may be extended to provide an expanded heat sink for thermal transfer and dissipation. A further feature of the heat sink structure 128 is that it is fabricated away from the air bearing surface 116 of the magnetic head to avoid any corrosion and/or tribological problems that can be created where tungsten components are exposed at the ABS; thus a portion of the fill 136 that surrounds the heat sink 128 is exposed at the ABS 116.

The significance of the use of tungsten to fabricate a heat sink structure for the magnetic head of the present invention is related to the low coefficient of thermal expansion (CTE) of tungsten as compared to other materials commonly used in the magnetic head, and Table 1 identifies some common head materials along with their CTE.

TABLE 1

| Material | CTE (10E−6) |
|---|---|
| AlTiC | 7.5 |
| Al₂O₃ | 7.0 |
| NiFe | 12 |
| Cu | 16.5 |
| W | 4.5 |

As is understood by those skilled in the art, the degree of protrusion of magnetic head components is substantially related to the CTE of the material that comprises the components. Significantly, the commonly used materials (copper and NiFe) have a relatively large CTE, whereby magnetic head components that are comprised of these materials contribute significantly to the thermal expansion of a heated magnetic head, and thus to the unwanted protrusion of these components into the air bearing gap. Tungsten, on the other hand, has a significantly lower CTE, such that its thermal expansion is significantly less than the other materials comprising the magnetic head. In fact, compared to the other materials, the tungsten heat sink inhibits protrusion by the other components due to its comparatively lower thermal expansion. Additionally, tungsten has a relatively high Young's Modulus of approximately 400 GPa, whereby a significant strain force must be placed upon it to produce a deformation in its shape. As a result, the tungsten heat sink 128 resists expansion due to physical forces of expanding neighboring components, and thereby helps to restrain the expansion of these neighboring components. Specifically, due to its relatively high Young's Modulus, the tungsten heat sink 128 serves to restrain the thermal expansion of the magnetic shield 40 upon which it is fabricated. Additionally, tungsten has good thermal conductivity, is non-magnetic, possesses fairly high electrical resistance, and has well known processing characteristics. The use of tungsten in a heat sink structure therefore serves to conduct unwanted heat away from the magnetic head structures, while also inhibiting the thermal expansion of the magnetic head structures. As a result, thermal protrusion of magnetic head structures is inhibited through the use of the tungsten heat sink structures, as described herein.

An alternative embodiment of the present invention is depicted in FIG. 4, which is a side cross-sectional view of a magnetic head 150. The magnetic head 150 of the present invention, as depicted in FIG. 4, includes many structures and components of the prior art magnetic head 38 depicted in FIG. 2, and similar structures are similarly numbered for ease of comprehension. Therefore, as depicted in FIG. 4, the magnetic head 150 of the present invention includes a substrate base 22 upon which a first magnetic shield 40 is fabricated. A read head sensor element 52 is disposed within electrical insulation layers 54 and 56, and a second magnetic shield 58 is formed upon the insulation layer 56. Thereafter, a tungsten heat sink 156 is fabricated upon the second magnetic shield 58. The tungsten heat sink 156 is fabricated within an alumina fill layer 162, and may be substantially identical to the tungsten heat sink 128 depicted in FIG. 3 and described hereabove. Additionally, it may be fabricated in a substantially identical fabrication process as is described hereabove for fabricating the heat sink 128 depicted in FIG. 3. The heat sink 156 functions to draw heat from the second magnetic shield 58 and other components of the magnetic head 150, thereby reducing thermal expansion of the magnetic head components and thus reducing unwanted protrusion of the magnetic head components into the air bearing gap.

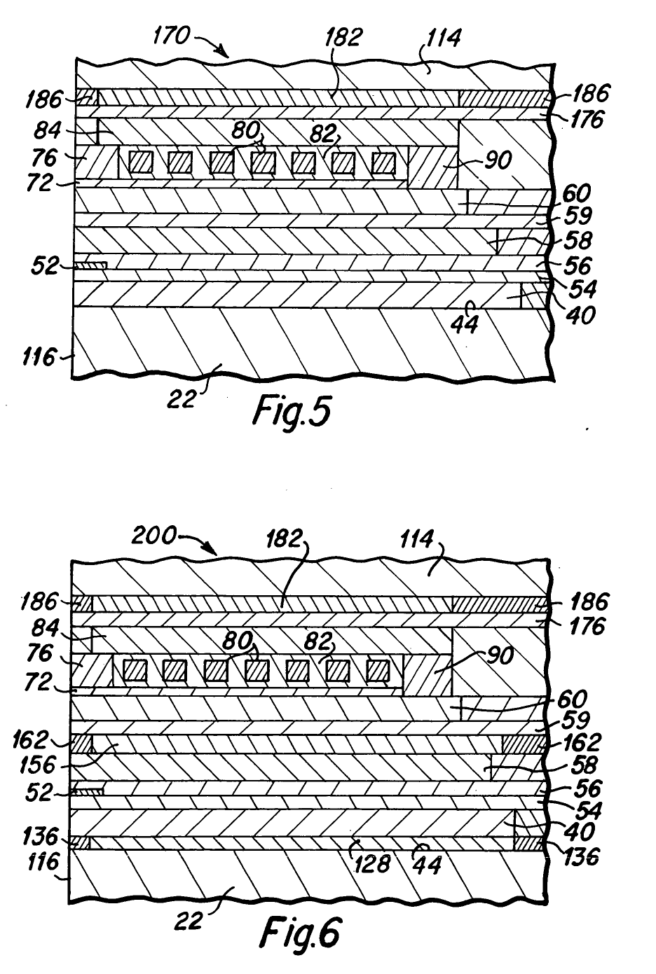

A further embodiment of the magnetic head of the present invention is depicted in FIG. 5, which is a cross-sectional view of the magnetic head 170. The magnetic head 170 as depicted in FIG. 5 includes many structure and components of the prior art magnetic head 38 depicted in FIG. 2, and similar structures are similarly numbered for ease of comprehension. Therefore, as depicted in FIG. 5, the magnetic head 170 of the present invention includes a first magnetic shield layer (S1) 40 that is formed on a slider substrate 22, a read head sensor element 52 that is disposed within insulating layers 54 and 56, and a second magnetic shield layer (S2) 58 that is formed upon the insulation layer 56. An electrical insulation layer 59 is deposited upon the S2 shield 58, and a first magnetic pole (P1) 60 is fabricated upon the insulation layer 59. A write gap layer 72 is deposited upon the P1 pole 60, a P2 magnetic pole tip 76 is fabricated upon the write gap layer and an induction coil having coil turns 80 is fabricated within insulation 82 upon the write gap layer 72. Thereafter, a yoke portion 84 of the second magnetic pole is fabricated in magnetic connection with the P2 pole tip 76, and through the back gap element 90 to the P1 pole 60. Thereafter, a thin insulation layer 176 may be deposited upon the yoke 84, and a tungsten heat sink 182 is thereafter fabricated upon the insulation layer 176. The tungsten heat sink 182 may be substantially identical to the heat sinks 128 and 156 described hereabove and depicted in FIGS. 3 and 4 respectively. Additionally, the tungsten heat sink 182 is fabricated within an alumina fill 186 upon the insulation layer 176 above the second magnetic pole yoke 84 of the magnetic head 170. It may be fabricated in substantially the same manner as has been described hereabove for the tungsten heat sinks 128 and 156. As with the other tungsten heat sinks, the heat sink 182 functions to remove heat from the magnetic head components, thereby limiting the thermal expansion of these components, and reducing the unwanted protrusion of the magnetic head components into the air bearing gap.

FIG. 6 is a cross-sectional view depicting an enhanced magnetic head 200 of the present invention. The magnetic head 200 includes many structures and components of the prior art magnetic head 38 depicted in FIG. 2, and similar structures are similarly numbered for ease of comprehension. Essentially, the magnetic head 200 depicted in FIG. 6 is formed to include all three of the tungsten heat shields 128, 156 and 182 that are individually depicted in FIGS. 3, 4 and 5. Therefore, the magnetic head 200 includes a first tungsten heat sink 128 and fill 136 that is formed upon a surface 44 of the slider substrate 22. The first magnetic shield 40 is then fabricated upon the tungsten heat sink 128, and a read head sensor element 52 is fabricated within electrical insulation layers 54 and 56. A second magnetic shield (S2) 58 is formed upon the insulation layer 56, and a second tungsten heat sink 156 and fill 162 is then fabricated upon the second magnetic shield. An electrical insulation layer 59 is then deposited upon the S2 shield 58, and a first magnetic pole (P1) 60 is fabricated upon the insulation layer 59.

Following the fabrication of the P1 pole 60, a write gap layer 72 is deposited upon the P1 pole 60, followed by the fabrication of a P2 magnetic pole tip 76. An induction coil structure including coil turns 80 is then fabricated within insulation 82 above the write gap layer 72. Thereafter, a yoke portion 84 of the second magnetic pole is fabricated in magnetic connection with the P2 pole tip 76, and through back gap element 90 to the P1 pole 60. A thin insulation layer 176 is fabricated upon the yoke portion 84, and a third tungsten heat sink 182 is fabricated within fill 186 upon the insulation layer 176. A further insulation layer 114 is deposited to encapsulate the magnetic head, and further fabrication steps are conducted such that an air bearing surface 116 is ultimately created and the magnetic head 200 is thereafter completely fabricated.

It is therefore to be understood that a magnetic head of the present invention may include any one of the tungsten heat'sinks 128, 156 or 182, any two of the tungsten heat sinks (128 and 156, 128 and 182, 156 and 182), or all three of the tungsten heat sinks 128, 156 and 182.

While the present invention has been shown and described with regard to certain preferred embodiments, it is to be understood that modifications in form and detail will no doubt be developed by those skilled in the art upon reviewing this disclosure. It is therefore intended that the following claims cover all such alterations and modifications that nevertheless include the true spirit and scope of the inventive features of the present invention.

What I claim is:

1. A magnetic head, comprising:
a substrate base;
a tungsten heat sink being disposed upon said substrate base; and
a magnetic shield being disposed upon said heat sink.

2. A magnetic head as described in claim 1 wherein said tungsten heat sink is disposed within a fill material layer.

3. A magnetic head as described in claim 2 wherein said tungsten heat sink is a generally flat layer having a thickness of from approximately 0.2μ to approximately 4μ.

4. A magnetic head as described in claim 3 wherein said tungsten heat sink is shaped to correspond to a shape of said magnetic shield.

5. A magnetic head as described in claim 1 further including a sensor being disposed above said magnetic shield;
a second magnetic shield being disposed above said sensor;
a second tungsten heat sink being disposed upon said second magnetic shield.

6. A magnetic head as described in claim 5 wherein said second tungsten heat sink is disposed within a fill material layer.

7. A magnetic head as described in claim 6 wherein said second tungsten heat sink is a generally flat layer having a thickness of from approximately 0.2μ to approximately 4μ.

8. A magnetic head as described in claim 7 wherein said second tungsten heat sink is shaped to correspond to a shape of said second magnetic shield.

9. A magnetic head as described in claim 5, further including a first magnetic pole being disposed above said second tungsten heat sink shield;
an induction coil being disposed above said first magnetic pole;
a second magnetic pole being disposed above said induction coil;
a third tungsten heat sink being disposed above said second magnetic pole.

10. A magnetic head as described in claim 9 wherein said third tungsten heat sink is disposed within a fill material layer.

11. A magnetic head as described in claim 10 wherein said third tungsten heat sink is a generally flat layer having a thickness of from approximately 0.2μ to approximately 4μ.

12. A magnetic head as described in claim 9 further including an insulation layer being disposed between said second magnetic pole and said third tungsten heat sink.

13. A magnetic head, comprising:
a substrate base;
a first magnetic shield being disposed above said substrate base;
a sensor being disposed above said first magnetic shield;
a second magnetic shield being disposed above said sensor;
a tungsten heat sink being disposed upon said second magnetic shield.

14. A magnetic head as described in claim 13 wherein said tungsten heat sink is disposed within a fill material layer.

15. A magnetic head as described in claim 14 wherein said tungsten heat sink is a generally flat layer having a thickness of from approximately 0.2μ to approximately 4μ.

16. A magnetic head as described in claim 15 wherein said tungsten heat sink is shaped to correspond to a shape of said second magnetic shield.

17. A magnetic head as described in claim 13, further including a first magnetic pole being disposed above said tungsten heat sink;
an induction coil being disposed above said first magnetic pole;
a second magnetic pole being disposed above said induction coil;
a second tungsten heat sink being disposed above said second magnetic pole.

18. A magnetic head as described in claim 17 wherein said second tungsten heat sink is disposed within a fill material layer.

19. A magnetic head as described in claim 18 further including an insulation layer being disposed between said second magnetic pole and said second tungsten heat sink.

20. A magnetic head, comprising:
a first magnetic pole;
an induction coil being disposed above said first magnetic pole;
a second magnetic pole being disposed above said induction coil;
a tungsten heat sink being disposed above said second magnetic pole.

21. A magnetic head as described in claim 20 wherein said tungsten heat sink is disposed within a fill material layer.

22. A magnetic head as described in claim 21 further including an insulation layer being disposed between said second magnetic pole and said tungsten heat sink.

23. A hard disk drive, comprising:
at least one hard disk being adapted for rotary motion upon a disk drive;
at least one slider device having a slider body portion being adapted to fly over said hard disk;
a magnetic head being formed on said slider body for writing data to said hard disk, said magnetic head including:
a substrate base;
a tungsten heat sink being disposed upon said substrate base; and
a magnetic shield being disposed upon said heat sink.

24. A hard disk drive as described in claim 23 wherein said tungsten heat sink is a generally flat layer having a thickness of from approximately 0.2μ to approximately 4μ.

25. A hard disk drive as described in claim 1 further including a sensor being disposed above said magnetic shield;
a second magnetic shield being disposed above said sensor;
a second tungsten heat sink being disposed upon said second magnetic shield.

26. A hard disk drive as described in claim 25 wherein said second tungsten heat sink is a generally flat layer having a thickness of from approximately 0.2μ to approximately 4μ.

27. A hard disk drive as described in claim 25, further including a first magnetic pole being disposed above said second tungsten heat sink shield;
an induction coil being disposed above said first magnetic pole;
a second magnetic pole being disposed above said induction coil;
a third tungsten heat sink being disposed above said second magnetic pole.

28. A hard disk drive as described in claim 27 further including an insulation layer being disposed between said second magnetic pole and said third tungsten heat sink.
